(19) United States
(12) Patent Application Publication
(10) Pub. No.: US 2007/0136033 A1
(43) Pub. Date: Jun. 14, 2007

(54) Method for designing insulation thickness of 22.9kV class High-temperature superconducting cable using conversion coefficient

(75) Inventors: Sang Hyun Kim, Jinju-si (KR); Dong Soon Kwag, Sacheon-si (KR); Hyeon Gweon Cheon, Sacheon-si (KR); Jae Hyeong Choi, Geoje-si (KR)

Correspondence Address: JORDAN AND HAMBURG LLP, 122 EAST 42ND STREET, SUITE 4000, NEW YORK, NY, 10168, US

(73) Assignee: Industry Academic Cooperation Foundation Gyeongsang National University, Jinju-si (KR)

(21) Appl. No.: 11/338,352

(22) Filed: Jan. 24, 2006

(30) Foreign Application Priority Data
Dec. 12, 2005 (KR) 10-2005-0121707

(51) Int. Cl. G06F 17/10

(52) U.S. Cl. 703/2

(57) ABSTRACT

Disclosed herein is a method for designing an insulation thickness of a 22.9 kV high-temperature superconducting cable wherein conversion coefficients for use in the transmission of electric power. In the insulation thickness designing method, differently from a conventional design method wherein only AC insulation breakdown electric-field, impulse insulation breakdown electric-field, and partial discharge initiation electric-field characteristics of an insulation sheet sample are applied to cable insulation thickness design equations, conversion coefficients, which are obtained in consideration of the effects of shape, area, and thickness along with the respective electric-field values, to the cable insulation thickness design equations, thereby achieving an increase in the accuracy of the insulation thickness of the high-temperature superconducting cable to be manufactured.

### BACKGROUND OF THE INVENTION

1. Field of the Invention

The present invention relates to a method for designing an insulation thickness of a 22.9 kV class high-temperature superconducting cable. More particularly, the present invention relates to a method for designing an insulation thickness of a high-temperature superconducting cable wherein conversion coefficients are applied to conventional cable insulation thickness equations using AC insulation breakdown electric-field, impulse insulation breakdown electric-field, and partial discharge initiation electric-field characteristics of an insulation material, thereby achieving an increase in the accuracy of the insulation thickness of the high-temperature superconducting cable to be manufactured.

2. Description of the Related Art

Nowadays, the demand of electric power throughout the world is on the rise due to a continuous economic growth. More particularly, recent continuing urbanization is causing a concentration of a great amount of electric power supply and demand. For this reason, the world has an urgent need for the development of a high-temperature superconducting cable featuring an extremely low power-transmission energy loss and a remarkably high power-transmission energy density, and therefore, such a high-temperature superconducting cable, which uses liquid nitrogen as a refrigerant, is being developed in various countries. Actually, as a high-temperature superconducting wire rod, having a high critical current and largely improved mechanical properties, has been recently developed, the study of high-temperature superconducting cables using the wire rod is being pursued with much enthusiasm.

Generally, the high-temperature conducting cable is electrically insulated in a composite insulation manner using liquid nitrogen and insulation paper. With the composite insulation manner wherein conductors are laminated by interposing thin polymer insulation tapes for electric insulation thereof, cooling shrinkage and thermal loss can be reduced and conventional oil-field (OF) cable insulation methods are applicable. Therefore, it can be said that, currently, the composite insulation manner has the highest practical application possibility. More particularly, in the case of an AC cable that depends on a dielectric loss, it employs polypropylene laminated paper (PPLP). The PPLP is a semi-synthetic paper of polypropylene and kraft paper, and has a low dielectric constant and dissipation factor.

In view of electric insulation, the high-temperature superconducting cable is designed in consideration of a withstand voltage of a composite insulator which consists of liquid nitrogen and insulation paper, and therefore, has a relatively simplified insulation design. That is, an insulation thickness of the high-temperature superconducting cable is calculated by inserting the withstand voltage to given insulation design equations based on AC insulation breakdown electric-field, impulse insulation breakdown electric-field, and partial discharge initiation electric-field characteristics of the composite insulator. However, to ensure stability of the cable which must be operated for a long time, dozens of experiments must be repeatedly performed to increase the reliability of experimental data In this case, it is difficult for all samples to be made into model cables for use in the experiments, and therefore, generally, a sheet sample having a minimum insulation configuration is used in the experiments. However, general solid insulators have different insulation characteristics in accordance with an insulation thickness of the cable and the area and shape of an electrode. For this reason, it is desirable that conversion coefficients, which are obtained in consideration of the effects of area, thickness, and shape via insulation breakdown experiments using a sheet sample, mini-model cable, and model cable, be applied to given insulation design equations. This ensures an improvement in cable operational reliability.

### SUMMARY OF THE INVENTION

Therefore, the present invention has been made in view of the above problems, and it is an object of the present invention to provide a method for designing an insulation thickness of a 22.9 kV class high-temperature superconducting cable wherein AC insulation breakdown electric-field, impulse insulation breakdown electric-field, and partial discharge initiation electric-field characteristics of a sheet sample of polypropylene laminated paper (PPLP), which satisfies standards of a Korean normal purchase specification published by the Korea Electronic Power Corporation and is used as insulation paper of the high-temperature superconducting cable, are set under a cryogenic liquid nitrogen atmosphere, and a mini-model cable and model cable are manufactured to set conversion coefficients between the sheet sample and the mini-model and model cables by use of the AC and impulse insulation breakdown electric-field characteristics.

In accordance with an aspect of the present invention, the above and other objects can be accomplished by the provision of a method for designing an insulation thickness of a 22.9 kV class high-temperature superconducting cable having a composite insulation configuration that consists of liquid nitrogen and insulation paper, wherein an AC conversion coefficient and an impulse conversion coefficient between a sheet sample and a model cable are applied to AC insulation breakdown electric-field, impulse insulation breakdown electric-field, and partial discharge initiation electric-field values of the sheet sample of polypropylene laminated paper as the insulation paper to fulfill cable insulation thickness design equations.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a graph illustrating an AC insulation breakdown electric-field characteristic of a sheet sample having butt-gap, which is one of three sheets of polypropylene laminated paper (PPLP) for the design of an insulation thickness of a 22.9 kV class high-temperature superconducting cable in accordance with the present invention;

FIG. 2 is a graph illustrating an impulse insulation breakdown electric-field characteristic of the sheet sample having butt-gap, which is one of three sheets of PPLP for the design of an insulation thickness of the 22.9 kV class high-temperature superconducting cable in accordance with the present invention;

FIG. 3 is a graph illustrating a partial discharge initiation electric-field characteristic of the sheet sample having butt-gap, which is one of three sheets of PPLP for the design of an insulation thickness of the 22.9 kV class high-temperature superconducting cable in accordance with the present invention; and

FIG. 4 is a table illustrating conversion coefficients M, which represent rates of insulation breakdown electric-field values of a sheet sample, mini-model cable and model cable with respect to the AC and impulse insulation breakdown electric-field values.

### DESCRIPTION OF THE PREFERRED EMBODIMENTS

Now, the present invention will be explained in more detail with reference to the accompanying drawings.

To design an electric insulation thickness of a high-temperature superconducting cable, first, AC insulation breakdown electric-field, impulse insulation breakdown electric-field, and partial discharge initiation electric-field characteristics of a sheet sample of polypropylene laminated paper (PPLP), which serves as cable insulation paper, must be set Then, a mini-model cable and model cable are manufactured to set an AC conversion coefficient M_{AC} and an impulse conversion coefficient Mᵢₘₚ, such that an insulation thickness of the high-temperature superconducting cable is determined based on the conversion coefficients. That is, the insulation thickness of the cable is designed by use of the above mentioned three insulation breakdown electric-field characteristics and conversion coefficients. With reference to a Korean normal purchase specification published by the Korea Electronic Power Corporation, an AC withstand voltage of a 22.9 kV class power cable is 80 kV, and an impulse withstand voltage BIL is 150 kV.

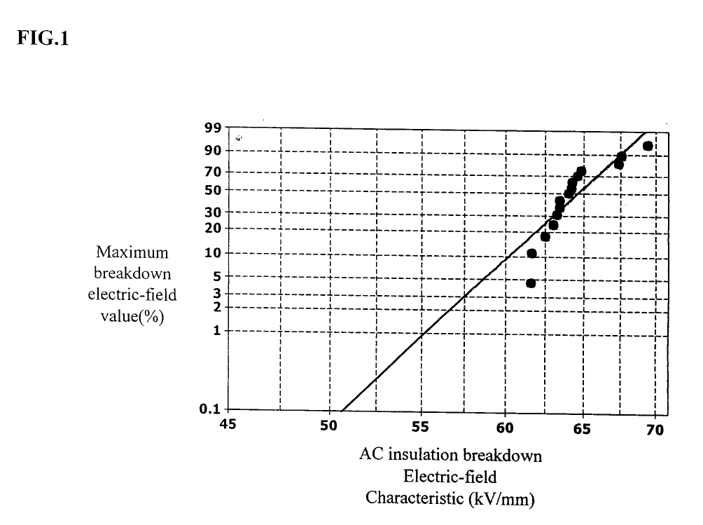

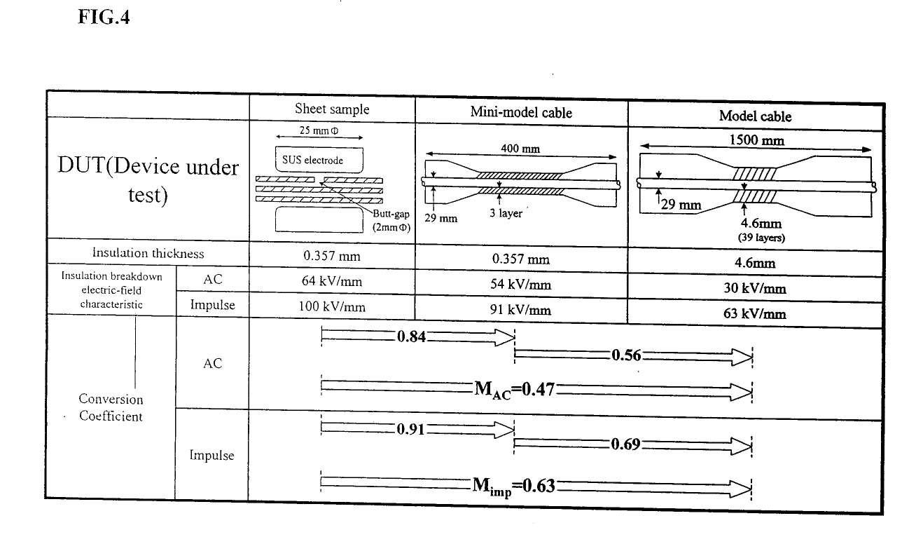

FIG. 1 illustrates an AC insulation breakdown electric-field characteristic of the PPLP sheet sample for the design of an AC insulation thickness of the high-temperature superconducting cable. Since the high-temperature superconducting cable of a paper insulation type is generally manufactured into a shape having butt-gap in consideration of an installation irregularity and a bending property that is required to be wound around a bobbin during transportation, an AC maximum breakdown electric-field value of the sheet sample having butt-gap, which is one of three sheets of PPLP, is adopted to approximately 50 kV/mm by use of Weibull distribution. Also, referring to FIG. 4, an AC conversion coefficient M_{AC} between the sheet sample and a model cable is obtained by dividing an AC insulation breakdown strength of the model cable by an AC insulation breakdown strength of the sheet sample. That is, the AC conversion coefficient M_{AC} is calculated as follows : 30 kV/mm÷64 kV/mm=0.47.

Based on the above calculation, an AC insulation thickness t_{AC} of the cable is calculated from the following Equation 1.

$${t}_{AC} = {r}_{1} \cdot [ exp ( \frac{{V}_{AC}}{{E}_{max ( AC )} {M}_{AC} \cdot {r}_{1}} ) - 1 ] \qquad Equation 1$$

where, the above coefficients are as follows:

AC withstand voltage V_{AC}=80 kV

AC maximum breakdown electric-field value E_{max(AC)}=50 kV/mm

AC conversion coefficient M_{AC}=0.47

inner conductor radius r₁=14.5 mm (former radius+wire rod thickness+inner semi-conductive layer thickness).

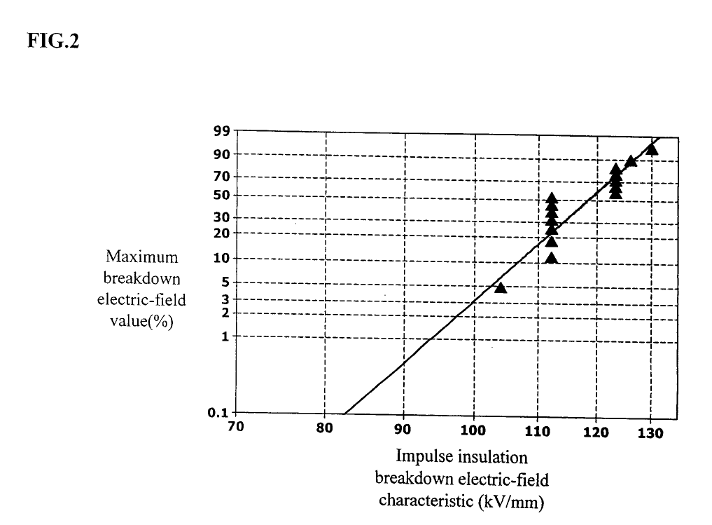

FIG. 2 illustrates an impulse insulation breakdown electric-field characteristic of the sheet sample having butt-gap, which is one of the three sheets of PPLP for the design of an impulse insulation thickness of the high-temperature superconducting cable. Similar to FIG. 1, an impulse maximum breakdown electric-field value of the sheet sample is adopted to 82 kV/mm by use of Weibull distribution. Referring to FIG. 4, an impulse conversion coefficient Mᵢₘₚ between the sheet sample and the model cable is obtained by dividing an impulse insulation breakdown strength of the model cable by an impulse insulation breakdown strength of the sheet sample. That is, the impulse conversion coefficient Mᵢₘₚ, is calculated as follows : 63 kV/mm÷100 kV/mm=0.63.

Based on the above calculation, an impulse insulation thickness tᵢₘₚ of the cable is calculated from the following Equation 2.

$${t}_{imp} = {r}_{1} \cdot [ exp ( \frac{BIL \cdot {L}_{1} \cdot {L}_{2} \cdot {L}_{3}}{{E}_{max ( AC )} {M}_{imp} \cdot {r}_{1}} ) - 1 ] \qquad Equation 2$$

where, the above coefficients are as follows:

impulse withstand voltage BIL=150 kV

impulse deterioration coefficient L₁=1.0

impulse temperature coefficient L₂=1.0

impulse design margin L₃ =1.32

impulse maximum breakdown electric field value Eₘₐₓ₍ᵢₘₚ₎=82 kV/mm

impulse conversion coefficient Mᵢₘₚ=0.63

inner conductor radius r₁=14.5mm (former radius+wire rod thickness+inner semi-conductive layer thickness).

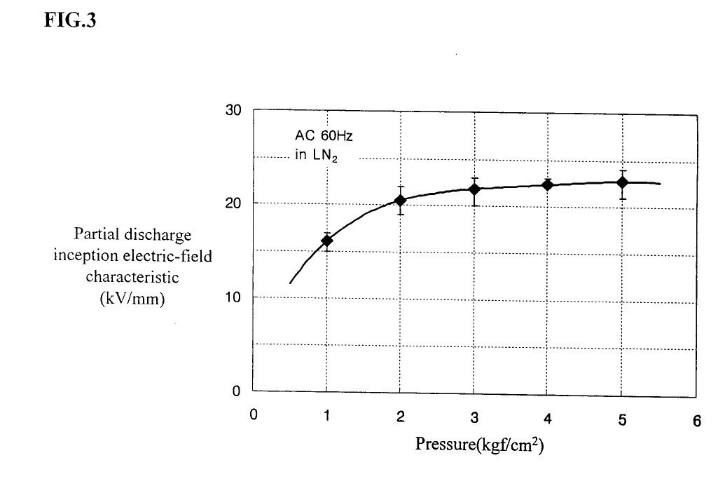

FIG. 3 illustrates a partial discharge initiation electric-field characteristic of the sheet sample having butt-gap, which is one of the three sheets of PPLP for the design of a partial discharge insulation thickness of the high-temperature superconducting cable. As will be understood from FIG. 3, since a partial discharge initiation electric-field value has a saturation point of approximately 4kg_{f}/cm² in accordance with an increase in the pressure of liquid nitrogen and an average operational pressure of the high-temperature superconducting cable is approximately 3 to 5kg_{f}/cm², a partial discharge initiation electric-field strength of 20 kV/mm under the above condition is set as an experimental value. Such a partial discharge uses an AC power source, and therefore, the AC conversion coefficient of 0.47 is adopted from FIG. 4. Accordingly, a partial discharge insulation thickness t_{PD} of the cable is calculated from the following Equation 3.

$${t}_{PD} = {r}_{1} \cdot [ exp ( \frac{\frac{{U}_{m}}{\sqrt{3}} \cdot {K}_{1} \cdot {K}_{2} \cdot {K}_{3}}{{E}_{max ( PD )} {M}_{AC} \cdot {r}_{1}} ) - 1 ] \qquad Equation 3$$

where, the above coefficients are as follows:

system maximum voltage Uₘ=25.8 kV

AC deterioration coefficient K₁=1.87

AC temperature coefficient K₂=1.0

AC design margin K₃=1.32

partial discharge initiation electric-field value E_{max(PD)}=20 kV/mm

AC conversion coefficient M_{AC}=0.47

inner conductor radius r₁=14.5mm (former radius+wire rod thickness+inner semi-conductive layer thickness).

As apparent from the above description, in a method for designing an insulation thickness of a 22.9 kV class high-temperature superconducting cable in accordance with the present invention, conversion coefficients are applied to AC insulation breakdown electric-field, impulse insulation breakdown electric-field, and partial discharge initiation electric-field characteristics of an insulation material, whereby a more stable and quantified insulation thickness design for a high-temperature superconducting cable can be accomplished. As a result, it can be understood that system stability in the application of the high-temperature superconducting cable can be more improved.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method for designing an insulation thickness of a 22.9 kV class high-temperature superconducting cable having a composite insulation configuration that consists of liquid nitrogen and insulation paper, wherein
an AC conversion coefficient and an impulse conversion coefficient between a sheet sample and a model cable are applied to AC insulation breakdown electric-field, impulse insulation breakdown electric-field, and partial discharge initiation electric-field values of the sheet sample of polypropylene laminated paper as the insulation paper to fulfill cable insulation thickness design equations.

2. The method as set forth in claim 1,
wherein an AC insulation thickness of the superconducting cable is calculated from the following equation:
$${t}_{AC} = {r}_{1} \cdot [ exp ( \frac{{V}_{AC}}{{E}_{max ( AC )} {M}_{AC} \cdot {r}_{1}} ) - 1 ]$$
t_{AC}: AC insulation thickness
V_{AC}: AC withstand voltage
E_{max(AC)}: AC maximum breakdown electric-field value
M_{AC}: AC conversion coefficient
r₁: inner conductor radius,
wherein an impulse insulation thickness of the superconducting cable is calculated from the following equation:
$${t}_{imp} = {r}_{1} \cdot [ exp ( \frac{BIL \cdot {L}_{1} \cdot {L}_{2} \cdot {L}_{3}}{{E}_{max ( AC )} {M}_{imp} \cdot {r}_{1}} ) - 1 ]$$
tᵢₘₚ: impulse insulation thickness
BIL: impulse withstand voltage
L₁: impulse deterioration coefficient
L₂: impulse temperature coefficient
L₃: impulse design margin
Eₘₐₓ₍ᵢₘₚ₎: impulse maximum breakdown electric field value Mᵢₘₚ: impulse conversion coefficient
r₁: inner conductor radius, and
wherein a partial discharge insulation thickness of the superconducting cable is calculated from the following equation:
$${t}_{PD} = {r}_{1} \cdot [ exp ( \frac{\frac{{U}_{m}}{\sqrt{3}} \cdot {K}_{1} \cdot {K}_{2} \cdot {K}_{3}}{{E}_{max ( PD )} {M}_{AC} \cdot {r}_{1}} ) - 1 ]$$
t_{PD}: partial discharge insulation thickness
Uₘ: system maximum voltage
K₁: AC deterioration coefficient
K₂: AC temperature coefficient
K₃: AC design margin
E_{max(PD)}: partial discharge initiation electric-field value M_{AC}: AC conversion coefficient
r₁: inner conductor radius.
